(19) United States
(12) Patent Application Publication
(10) Pub. No.: US 2017/0312891 A1
(43) Pub. Date: Nov. 2, 2017

(54) CLAMPING DEVICE

(71) Applicant: HOMAG GMBH, Schopfloch (DE)

(72) Inventors: Volker SCHMIEDER, Mössingen (DE); Christian STURM, Sulz am Neckar (DE); Stefan FRIESE, Pfalzgrafenweiler (DE)

(73) Assignee: HOMAG GMBH, Schopfloch (DE)

(21) Appl. No.: 15/522,982

(22) PCT Filed: Nov. 3, 2015
(86) PCT No.: PCT/EP2015/075620

§ 371 Date: Apr. 28, 2017

(30) Foreign Application Priority Data
Nov. 3, 2014 (DE) 10 2014 222 423.3

(51) Int. Cl. B25B 5/14; B25B 5/00; B25B 5/06; B27C 5/06

(52) U.S. Cl. CPC B25B 5/142; B27C 5/06; B25B 5/003; B25B 5/061

(57) ABSTRACT

The invention relates to a clamping device for a workpiece, comprising a lower clamping element and an upper clamping element which form a workpiece holder.

### TECHNICAL FIELD

The invention relates to a clamping device for a workpiece, in particular for a workpiece made of wood, plastic or the like, in particular according to the preamble of claim 1.

### PRIOR ART

During the machining of workpieces, such as in particular window or door elements, preferably made of wood, plastic or the like, a multiplicity of different profiles are customarily milled into the workpiece, for which purpose extensive machining operations are necessary especially also of the lateral surfaces in the longitudinal direction of the workpieces.

In order to realize the increasing requirement in recent times for increased light incidence in living rooms, the width of the individual window parts is being reduced ever further as of late. As a result, the workpiece only still has a small free clamping surface for securing the workpiece in a clamping device for material-removing machining. Typically, such a window element passes through a plurality of machining steps, wherein one side is contoured in each working step. The clamping of window elements with an advanced profiling is particularly difficult because of the small free clamping surface.

The prior art discloses clamping devices for machining workpieces, comprising an upper clamping element and a lower clamping element, wherein the workpiece can be clamped between said two clamping elements. The two clamping elements rest here on the lower free supporting surface and the upper free supporting surface of the window elements. However, workpieces can have such a small length that they can no longer be usefully secured between a plurality of clamping devices and, as a result, when clamped in only one clamping device, may be rotated and/or displaced during the material-removing machining.

DE 101 37 839 C5 has previously disclosed clamping devices which have a plurality of stops in their longitudinal direction, wherein the workpiece can be placed with one longitudinal side against the stops in order to ensure lateral guidance, transversely with respect to the longitudinal direction.

DE 199 38 851 A1 has disclosed adjustment stops which are arranged releasably and serve for manual alignment of the workpiece in a longitudinal direction.

Furthermore, the document DE 10 2011 012 739 A1 has disclosed the provision of at least one stop which can be positioned in an automated manner in a direction transversely with respect to the longitudinal direction such that the workpiece can be placed with a side surface against the at least one stop in order to protect the workpiece during the machining against a possible rotation in a plane transversely with respect to the longitudinal direction.

The document DE 20 2007 040 580 discloses stops which are used for precise positioning of the workpiece, wherein said stops are adjustable in a direction transversely with respect to the longitudinal direction.

The window elements which are already profiled on one side surface frequently have such a small clamping surface that the contact surface, which is necessary for stable securing, between the clamping elements and the workpiece is not present. In addition, clamping despite the stop elements known from the prior art may lead because of the low height of the workpiece to the two clamping elements being so closely adjacent in the clamped state that the tool no longer reaches the workpiece. Furthermore, window elements which have already been profiled would be clamped in such a manner that the window element would project upward or downward over the clamping elements and, as a result, damage to the workpiece may occur during the machining because of bending loads.

### DESCRIPTION OF THE INVENTION, OBJECT, SOLUTION, ADVANTAGES

The invention is based on the object of designing a clamping device in such a manner that even narrow and/or short workpieces, in particular even with side surfaces which have already been profiled, can be clamped in such a stable manner that material-removing machining is also possible without the risk of slipping or rotating of the workpiece and/or without damage to the workpiece.

This object is achieved with the features of claim 1.

An exemplary embodiment of the invention relates to a clamping device for a workpiece, comprising a lower clamping element and an upper clamping element which form a workpiece holder, wherein the height of the upper clamping element is adjustable relative to the lower clamping element, wherein the workpiece has at least one outer surface arranged on the lower side and/or upper side and can be inserted into the clamping device, with a clamping support element which can be provided in the clamping device, wherein the clamping support element has at least one outer surface arranged on the upper side and/or lower side, and the workpiece and the clamping support element can be clamped together in the clamping device, wherein, when the workpiece and the clamping support element are clamped in the clamping device, the at least one outer surface arranged on the lower side and/or upper side of the workpiece and the at least one outer surface arranged on the upper side and/or lower side of the clamping support element lie flat one on top of the other. This has the advantage that even a workpiece having a side surface already premachined can therefore be securely clamped in the region of the premachined side surface because for clamping surface produced by the premachining is used for the clamping. The clamping support element cannot only be used here for positioning, but it can also absorb forces such as act on the clamping support element during the clamping.

It is advantageous here if at least one such clamping device or a plurality thereof is or are provided in a workpiece table by means of which at least individual workpieces can be machined in their longitudinal direction, and said workpieces and/or the clamping support element can be inserted into the clamping element of the workpiece table in an automated manner. The workpiece table can have clamping elements for receiving only one workpiece in a clamping position, or alternatively the workpiece table can also provide clamping elements for receiving a workpiece in one of opposite clamping positions.

The clamping device according to the invention advantageously has two lower clamping elements and two upper clamping element, and therefore the clamping device forms two workpiece holders. As a result, two workpieces can be received and also machined at the same time in one clamping device, or, after reclamping, an opposite side surface can also be machined.

Expediently, workpiece holders in a clamping device according to the invention which forms two workpiece holders lie opposite each other so that reclamping between the two workpiece holders is made possible in a simple manner.

It is of advantage if the clamping support element is designed as a separate component and can be inserted into the clamping device. The clamping support element can therefore be selected appropriately for a workpiece.

Furthermore, it is expedient if the lower and/or upper clamping element is/are formed in such a manner that the clamping support element is formed integrally with the lower and/or upper clamping element. It is therefore optionally possible to dispense with the working step of inserting the clamping support element.

It is furthermore advantageous if a clamping support element is extendable out of the lower clamping element, and/or a clamping support element is extendable out of the upper clamping element. In particular, it is of advantage if the clamping support element is extendable in the vertical direction. This has the advantage that a clamping support element can no longer be inserted separately, but rather is already integrated and is extendable or retractable in a controlled manner. This is particularly advantageous for an automated machining process.

It is also expedient that the clamping support element, which is formed as an independent part, can be inserted into the clamping device in an automated manner. As a result, the cycle rate during the machining can optionally be reduced, and it is also advantageous that a suitable clamping support element can be selected and inserted in an automated manner. As a result, the clamping support element can be optimally selected for the workpiece.

Furthermore, it is expedient that the clamping support element, which is designed as an independent part, is extendable out of the clamping device in an automated manner.

It is of advantage if the clamping support element is connectable to the lower clamping element and/or to the upper clamping element in a form-fitting manner so that the position of the clamping support element relative to the clamping element is unambiguously defined in order thereby to prevent possible damage to the workpiece because of erroneous positioning of the clamping support element.

So that a clamping support element can be used for different workpieces, it is advantageous that the clamping support element is of stepped design and has a plurality of upper-side outer surfaces, and therefore a respective workpiece can be placed depending on its design onto one of the upper-side outer surfaces.

It is expedient that at least one of the upper-side outer surfaces of the clamping device is surface-treated in such a manner that its coefficient of friction with respect to the workpiece is increased, as a result of which, even at a relatively low clamping force, a higher holding force arises between the workpiece and the clamping support element.

In this case, it is advantageous that at least one upper-side outer surface is provided with a pincushion or is designed in the manner of a pincushion. Better adhesion is thereby achieved.

According to a further concept according to the invention, the clamping device has at least one stop element which can be provided in the clamping device such that the workpiece can be placed with a lateral outer surface against the at least one stop element, as a result of which securing is achieved against rotation especially in the case of a shorter workpiece.

In this case, it is advantageous that at least one of the stop elements is formed by a clamping support element. As a result, a separate stop element is not required.

At least one of the stop elements is advantageously formed by an element connected to the lower clamping element and/or upper clamping element and/or to the clamping support element. Such a connected element can be used with or without a clamping support element.

In this case, it is expedient that the connected element is a plug-in element or screw element which is connectable to the lower clamping element and/or to the upper clamping element and/or to the upper clamping element. This makes rapid attachment or removal of the connectable plug-in element possible.

It is advantageous that the at least one stop element is extendable out of the lower clamping element and/or out of the upper clamping element, in particular is extendable in the vertical direction. As a result, the cycle times can be increased because the extension requires less time in relation to an insertion.

The object with respect to the method is achieved with the features of claim 18.

An exemplary embodiment of the invention relates to a method for clamping a workpiece in a clamping device, in particular as claimed in one of the preceding claims, wherein the clamping device is formed with a lower clamping element and an upper clamping element which form a workpiece holder, wherein the height of the upper clamping element is adjustable relative to the lower clamping element, wherein the workpiece has at least one outer surface arranged on the lower side and can be inserted into the clamping device, with a clamping support element which can be provided in the clamping device, wherein the clamping support element has at least one outer surface arranged on the upper side, and the workpiece and the clamping support element can be clamped together in the clamping device, wherein first of all the clamping support element is provided in the clamping device and then the workpiece is introduced into the clamping device, wherein, when the workpiece and the clamping support element are clamped in the clamping device, the at least one outer surface arranged on the lower side of the workpiece and the at least one outer surface arranged on the upper side of the clamping support element lie flat one on top of the other. As a result, as already described above, the clamping in particular of narrow workpieces is made possible.

It is furthermore of advantage that the clamping support element is inserted into the clamping device in an automated manner and/or is extended out of the lower and/or the upper clamping element in an automated manner. This increases the machining efficiency.

It is expedient that the clamping support element is formed integrally with the lower and/or the upper clamping element and this clamping element formed in such a manner is inserted into the clamping device.

It is furthermore advantageous that the workpiece has a lateral outer surface, and at least one stop element is provided in the clamping device, and therefore the workpiece is placed with a lateral outer surface against the at least one stop element.

Further advantageous refinements are described by the description below of the figures and by the dependent claims.

### BRIEF DESCRIPTION OF THE FIGURES OF THE DRAWING

The invention is explained in more detail below on the basis of at least one exemplary embodiment with reference to the figures of the drawing, in which:

FIG. 1 shows a side view of a first exemplary embodiment of a clamping device according to the invention with a clamping support element,

FIG. 2 shows a side view of a second exemplary embodiment of a clamping device according to the invention with a lower clamping element which integrally forms a clamping support element,

FIG. 3 shows a side view of a third exemplary embodiment of a clamping device according to the invention with a step-shaped clamping support element,

FIG. 4 shows a side view of a further exemplary embodiment of a clamping device with stop elements, and

FIG. 5 shows a top view of a further exemplary embodiment of the clamping device according to the invention with stop elements.

### PREFERRED EMBODIMENT OF THE INVENTION

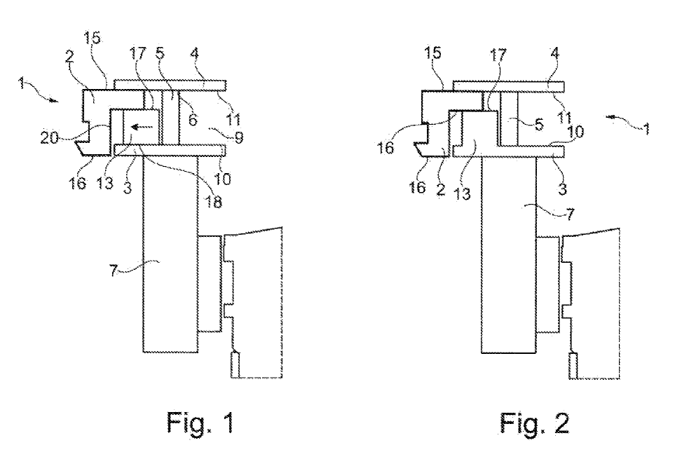

FIG. 1 shows a clamping device 1 for clamping workpieces 2 made of wood, plastic or the like, in order to be able to machine said workpieces in a machining device.

The clamping device 1 has a lower clamping element 3 and an upper clamping element 4. The height of the upper clamping element 4 is movable relative to the lower clamping element 3, the height of which is arranged immovably. Alternatively, the height of the lower clamping element 3 can also be movable.

The upper clamping element 4 has a plate shape or a plate-like shape and is fixedly connected to a positioning rod 5. The connection takes place at an upper end 6 of the positioning rod 5, as can be seen in FIG. 1. This can optionally also be achieved in a different way. This connection between the upper clamping element 4 and the positioning rod 5 is advantageously screwed, wherein it is furthermore possible to design the positioning rod 5 and the upper clamping element 4 as an integral component.

As shown in FIG. 1, the lower clamping element 3 has a plate shape or a plate-like shape and is fixedly connected to the workpiece table 7, wherein this connection is advantageously screwed in particular in the vertical direction. This connection can also be formed in some other way.

The positioning rod 5 is connected to a drive mechanism (not shown) located below the lower clamping element 3. The lower clamping element 3 therefore has an opening or recess so that the positioning rod 5 can be arranged running in its longitudinal direction through the lower clamping element 3 in the vertical direction. It is also possible for the lower clamping elements 3 to be formed from two individual plates or plate-like components, wherein these are fixedly connected to the workpiece table 7, and the positioning rod 5 runs in the vertical direction between the two opposite lower clamping elements 3.

The lower end (not illustrated) of the positioning rod 5 is connected to a drive mechanism (not illustrated) in such a manner that the height position of the positioning rod can be changed in the vertical direction. Since the positioning rod 5 is fixedly connected to the upper clamping element 4, the vertical distance of the upper clamping element 4 from the lower clamping element 3 can be changed by the drive mechanism (not shown). It is possible for the drive mechanism to be a hydraulic, pneumatic or electric motor drive.

The lower clamping element 3 and the upper clamping element 4 together form a workpiece holder 9. On an upper side, the lower clamping element 3 has at least one supporting surface 10, and the upper clamping element 4 has at least one contact surface 11 on a lower side. In a development of the clamping elements, clamping pads (not shown) which can serve for protecting the workpiece 2 and the upper surface thereof or for better securing of the workpiece 2 can also be attached to the supporting surface 10 of the lower clamping element 3 and/or to the contact surface 11 of the upper clamping element 4. For example, such clamping pads can be formed from plastic or rubbery material.

The clamping device 1 has at least one upper clamping element 4. If two upper clamping elements 4 are provided, they can be designed in particular as an integral component. They can also be of two-part design. The clamping device 1 has at least one lower clamping element 3. If two lower clamping elements 3 are provided, they can be designed as two separate components or can be designed connected as a common component. The exemplary embodiment of the clamping device 1 that is illustrated in FIG. 1 has in each case two upper clamping elements 4 and two lower clamping elements 3 and therefore forms two workpiece holders 9.

In the case of a clamping device 1 according to FIG. 1 with two workpiece holders 9, said two workpiece holders 9 advantageously lie opposite each other.

Provided in the workpiece holder 9 of the clamping device 1, in addition to the workpiece 2, is, according to the invention, a clamping support element 13, wherein the clamping support element 13 and the workpiece 2 can be clamped in together.

As shown in FIG. 1, the clamping support element 13 can be an additional insertable part. The clamping support element 13 can be inserted into the workpiece holder 9 in an automated manner or manually by at least one machine operator. The clamping device 1 can advantageously also have at least one stop element (not illustrated) which can ensure an exact alignment of the clamping support element 13. The clamping support element 13 can be removed from the workpiece holder 9 manually by at least one machine operator. An automated removal of the clamping support element 13 is furthermore possible.

The clamping support element 13 and the lower clamping element 4 or the upper clamping element 3 are expediently connectable to each other in a form-fitting manner. According to FIG. 1, a form-fitting connection of the insertable clamping support element 13 to the lower clamping element 3 is expedient.

The workpiece 2 which is insertable and is to be clamped in the clamping device 1 for the machining has at least one upper side surface 15 which is an outer surface arranged on the upper side, and a lower side surface 16 which is an outer surface arranged on the lower side. In the case of workpieces 2 which have already been repeatedly machined, a plurality of upper side surfaces 15 and lower side surfaces 16 typically form. The surface of the individual upper side surfaces 15 or individual lower side surfaces 16 can be small relative to the contact surface 11 on the upper clamping element 4 or the supporting surface 10 on the lower clamping element 3, and therefore a satisfactory clamping surface would be lacking.

The clamping support element 13 has at least one upper surface 17 which is an outer surface arranged on the upper side, and/or at least one lower surface 18 which is an outer surface arranged on the lower side. The contour of the outer surface of the clamping support element 13 is configured in such a manner that, in a clamped state, at least one upper surface 17 of the clamping support element 13 and a lower side surface 16 of the workpiece 2 lie flat one on top of the other, or at least one lower surface 18 of the clamping support element 13 and an upper side surface 15 of the workpiece 2 lie flat one on top of the other.

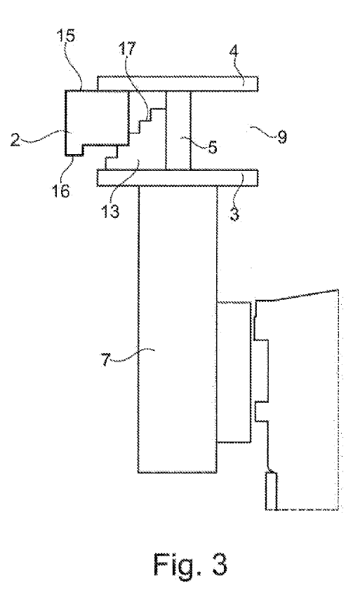

According to FIG. 1, the clamping support element has an upper surface 17 and a lower surface 18. As illustrated in FIG. 3, the clamping support element 13 can also have a plurality of upper surfaces 17 or a plurality of lower surfaces 18. In FIG. 1, the cross section of the clamping support element 13 is approximately rectangular. In FIG. 3, the clamping support element 13 has a step-shaped cross section with a plurality of upper surfaces 17.

The arrangement and configuration of the upper surfaces 17 or lower surfaces 18 of the clamping support element 13 can be adapted to the design of the upper side surfaces 15 of the workpiece 2 or of the lower side surfaces 16 of the workpiece 2 in such a manner that the horizontal contact surface between the workpiece 2 and the clamping support element 13 is as large as possible. The plurality of upper surfaces 17 or lower surfaces 18 is therefore typically arranged in a stepped manner with respect to one another, as shown in FIG. 3.

FIG. 2 shows a further exemplary embodiment of a clamping device 1 in which the lower clamping element 3 is designed in such a manner that the clamping support element 13 is formed integrally with the lower clamping element 3. It is furthermore possible that the upper clamping element 4 is designed in such a manner that the clamping support element 13 can be formed integrally with the upper clamping element 4. The further features substantially correspond to those shown in FIG. 1.

In an advantageous development (not illustrated) of the clamping device 1, the latter is designed in such a manner that a clamping support element 13 is extendable into the workpiece holder 9. Advantageously, a clamping support element 13 is designed to be extendable out of the upper clamping element 3 and/or the lower clamping element 4 into the workpiece holder. In particular, the extension of a clamping support element 13 in the vertical direction is expedient. The extension can take place here both in an automated manner and also manually.

The clamping device 1 therefore has at least one workpiece holder 9, wherein provided in the at least one workpiece holder 9 is a clamping support element 13 which can be configured as an additional insertable component or can be formed integrally with the lower clamping element 3, or can be formed integrally with the upper clamping element 4, or can be extendable.

Advantageously, the contact surface 11 of the upper clamping element 4 or the supporting surface 10 of the lower clamping element 3 or a plurality of upper surfaces 11 and/or lower surfaces 18 of the clamping support element 13 are surface-treated in such a manner that the coefficient of friction between the surfaces involved is increased. Said surfaces are typically roughened or suitably coated, for example sandblasted. The upper surfaces can advantageously also be designed as pincushions or in the manner of pincushions. This can be achieved by short, thin, needle-like elements which, for example, are arranged perpendicularly to the outer surface and impart additional grip to the workpiece 3 made of wood.

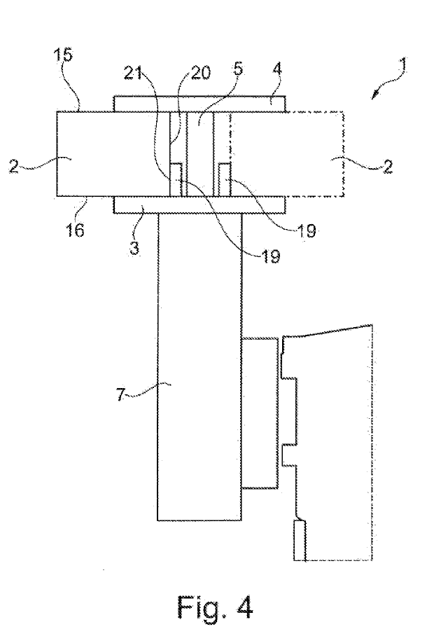

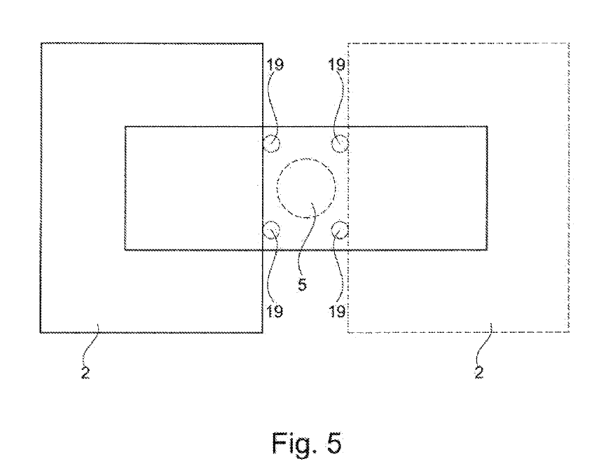

FIG. 4 shows a clamping device 1 with at least one stop element 19 which is arranged in the workpiece holder 9, wherein the workpiece 1 can be placed with at least one lateral outer surface 20 onto a side surface 21 of the stop element 19. FIG. 4 and FIG. 5 show embodiments in which two stop elements 19 are provided in order to prevent rotation of the workpiece 2 in the workpiece holder 9.

In an advantageous development of a clamping device 1, the provided clamping support element 13 forms the at least one stop element 19 itself, wherein, in a clamped state, there is at least one vertical contact surface and at least one horizontal contact surface between the workpiece 2 and the clamping support element 13, and the workpiece 2 and the clamping support element 13 is also in contact with said contact surfaces.

A stop element 19 is advantageously designed as an element which is connectable to the upper clamping element 4 and/or to the lower clamping element 3 and/or to the clamping support element, wherein the one element can be designed in particular as a screw element or as a plug-in element for the purpose of the connection.

Alternatively, it is advantageous if the at least one stop element 19 is extendable out of the lower clamping element 3 and/or the upper clamping element 4, as in the direction of the workpiece holder 9, in particular in the vertical direction. The stop elements 19 are expediently extended in an automated manner.

The clamping operation is explained in more detail below.

In order to clamp a workpiece 2 in the clamping device 1 according to the invention, the drive mechanism moves the upper clamping element 4 into a satisfactorily high position. The workpiece 2 is then inserted into the clamping device 1, wherein the insertion takes place in an automated manner by a gripper or manipulator or manually by at least one machine operator. Prior to the insertion of the workpiece 2, the clamping support element 13 can be provided in the clamping device 1 if required. The clamping support element is advantageously inserted in an automated manner or manually into the clamping device 1 and is extended out of the clamping device 1 in an automated manner or manually. It is furthermore possible for the clamping support element 13 to be formed integrally with the lower clamping element 3 and/or with the upper clamping element 4 and for the lower clamping element 3 and/or the upper clamping element 4 to be inserted into the clamping device 1. After the positioning of the workpiece 2, the upper clamping element 4 is moved downward, and therefore the workpiece 2 and the clamping support element 13 are clamped together in the clamping device 1 in such a manner that at least one upper surface 17 of the clamping support element 13 and a lower side surface 16 of the workpiece 2 lie flat one on top of the other, or at least one lower surface 18 of the clamping support element 13 and an upper side surface 15 of the workpiece 2 lie flat one on top of the other.

It is furthermore possible for the clamping device 1 alternatively or additionally to have at least one stop element 19, wherein the workpiece 2 is inserted into the clamping device 1 in such a manner that a lateral side surface 20 of the workpiece 2 lies against at least one side surface of the stop element 19.

The figures indicate a possible procedure during the machining of the workpieces 2 with a clamping device 1 which has two workpiece holders 9, wherein first of all, by clamping the workpiece 2 in one of the two workpiece holders 9, one of the lateral side surface 20 of the workpiece 2 can be contoured. The workpiece 2 is then inserted without rotation into the other workpiece holder 9, or alternatively the workpiece 2 is rotated about 180° and inserted into the same workpiece holder 9 such that another of the lateral side surfaces 20 can be machined. The provision of a clamping support element 13 is advantageous, in particular in the second machining step, in order to be able to better clamp an outer surface which has already been contoured.

### LIST OF REFERENCE SIGNS

1 Clamping device
2 Workpiece
3 Lower clamping element
4 Upper clamping element
5 Positioning rod
6 Upper end of the positioning rod
7 Workpiece table
9 Workpiece holder
10 Supporting surface of the lower clamping element
11 Contact surface of the upper clamping element
13 Clamping support element
15 Upper side surface of the workpiece
16 Lower side surface of the workpiece
17 Upper surface of the clamping support element
18 Lower surface of the clamping support element
19 Stop element of the workpiece holder
20 Lateral side surface of the workpiece
21 Side surface of the stop element

1. A clamping device for a workpiece, comprising a lower clamping element and an upper clamping element which form a workpiece holder, wherein the height of the upper clamping element is adjustable relative to the lower clamping element, wherein the workpiece has at least one outer surface arranged on the lower side and/or upper side and can be inserted into the clamping device, with a clamping support element which can be provided in the clamping device, wherein the clamping support element has at least one outer surface arranged on the upper side and/or lower side, and the workpiece and the clamping support element can be clamped together in the clamping device, wherein, when the workpiece and the clamping support element are clamped in the clamping device, the at least one outer surface arranged on the lower side and/or upper side of the workpiece and the at least one outer surface arranged on the upper side and/or lower side of the clamping support element lie flat one on top of the other.

2. The clamping device as claimed in claim 1, wherein the clamping device has two lower clamping elements and two upper clamping elements, and therefore two workpiece holders are formed.

3. The clamping device as claimed in claim 2, wherein the two workpiece holders lie opposite each other.

4. The clamping device as claimed in claim 1, wherein the clamping support element can be inserted into the clamping device.

5. The clamping device as claimed in claim 1, wherein the lower and/or the upper clamping element are/is designed in such a manner that the clamping support element is formed integrally with the lower and/or with the upper clamping element.

6. The clamping device as claimed in claim 1, wherein a clamping support element is extendable out of the lower clamping element, and/or a clamping support element is extendable out of the upper clamping element, such as in particular is/are extendable in the vertical direction.

7. The clamping device as claimed in claim 3, wherein the clamping support element can be inserted in an automated manner.

8. The clamping device as claimed in claim 6, wherein the at least one clamping support element is extendable in an automated manner.

9. The clamping device as claimed in claim 3, wherein the clamping support element is connectable to the lower or to the upper clamping element in a form-fitting manner.

10. The clamping device as claimed in claim 1, wherein the clamping support element is of stepped design and has a plurality of upper-side and/or lower-side outer surfaces.

11. The clamping device as claimed in claim 1, wherein the at least one upper-side and/or lower-side outer surface is surface-treated in such a manner that its coefficient of friction with respect to the workpiece is increased.

12. The clamping device as claimed in claim 11, wherein at least one upper-side and/or lower-side outer surface is provided with a pincushion or is designed in the manner of a pincushion.

13. A clamping device for a workpiece, comprising a lower clamping element and an upper clamping element which form a workpiece holder, wherein the height of the upper clamping element is adjustable relative to the lower clamping element, wherein the workpiece has at least one outer surface arranged on the lower side and/or upper side and a lateral outer surface and can be inserted into the clamping device, in particular as claimed in claim 1, with at least one stop element which can be provided in the clamping device such that the workpiece can be placed with its lateral outer surface against the at least one stop element.

14. The clamping device as claimed in claim 13, wherein at least one of the stop elements is formed by a clamping support element.

15. The clamping device as claimed in claim 13, wherein at least one of the stop elements is formed by an element connected to the lower clamping element and/or to the upper clamping element and/or to the clamping support element.

16. The clamping device as claimed in claim 15, wherein the connected element is a plug-in element or screw element which is connectable to the lower clamping element and/or to the upper clamping element and/or to the clamping support element.

17. The clamping device as claimed in claim 13, wherein the at least one stop element is extendable out of the lower clamping element and/or out of the upper clamping element, such as in particular is extendable in the vertical direction.

18. A method for clamping a workpiece in a clamping device, in particular as claimed in claim 1, wherein the clamping device is formed with a lower clamping element and an upper clamping element which form a workpiece holder, wherein the height of the upper clamping element is adjustable relative to the lower clamping element, wherein the workpiece has at least one outer surface arranged on the lower side and/or on the upper side and can be inserted into the clamping device, with a clamping support element which can be provided in the clamping device, wherein the clamping support element has at least one outer surface arranged on the upper side and/or on the lower side, and the workpiece and the clamping support element can be clamped together in the clamping device, wherein first of all the clamping support element is provided in the clamping device and then the workpiece is introduced into the clamping device, wherein, when the workpiece and the clamping support element are clamped in the clamping device, the at least one outer surface arranged on the lower side and/or upper side of the workpiece and the at least one outer surface arranged on the upper side and/or on the lower side of the clamping support element lie flat one on top of the other.

19. The method as claimed in claim 18, wherein the at least one clamping support element is inserted into the clamping device in an automated manner or is extended out of the lower clamping element and/or the upper clamping element in an automated manner.

20. The method as claimed in claim 18, wherein the clamping support element is formed integrally with the lower or upper clamping element and this clamping element formed in such a manner is inserted into the clamping device.

21. The method in particular as claimed in claim 18, wherein the workpiece has a lateral outer surface, wherein at least one stop element is provided in the clamping device, and therefore the workpiece is placed with its lateral outer surface against the at least one stop element.
